(19) United States
(12) Patent Application Publication
(10) Pub. No.: US 2002/0145992 A1
(43) Pub. Date: Oct. 10, 2002

(54) URL acquisition and management

(76) Inventor: Gregory S. Holt, New York, NY (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/102,115

(22) Filed: Mar. 20, 2002

Related U.S. Application Data
(60) Provisional application No. 60/277,412, filed on Mar. 20, 2001.

(51) Int. Cl. H04Q 7/24

(52) U.S. Cl. 370/338

(57) ABSTRACT

A system and method for managing the registration of internet URLs, comprising first and second databases and a processor. The first database contains fields in which a first set of data are stored, the first set of data including, for a selected URL, user-generated data characterizing an application to register a URL. The processor is operable to access on-line information to determine whether the URL is already registered and, if so, to compare on-line information regarding the URL and the first set of data. After any discrepancies between the first set of data and the on-line information are resolved, the processor stores in the second database a second set of data, the second set of data including, for said URL, the first set of data with any discrepancies corrected and augmented by registration data from the on-line information.

### RELATED APPLICATION

This application claims priority under 35 U.S.C. 119(e) to provisional application serial No. 60/277,412 filed Mar. 20, 2001.

### FIELD OF THE INVENTION

This invention relates to the registration and management of large numbers of internet Uniform Resource Locators (URLs).

### BACKGROUND OF THE INVENTION

With the development in recent years that the global computer communications network known as the Internet has become a medium for electronic commerce, it has become commercially important for many organizations not only to secure registration of specific domain names (officially known as Uniform Resource Locators or URLs), but also for some companies to obtain registration of hundreds, thousands, or even tens of thousands of URLs. Registration is made by filing a successful application with a sanctioned registrar and paying the requisite fee. A registration for a desired URL can only be obtained if another party has not already registered that URL. However, URLs are registered for defined periods, typically one or two years, and if the registration is not renewed on a timely basis, it is then cancelled and another party can apply for registration of the same URL. This can be quite problematic for the original owner of the URL; people who are accustomed to going to browsing a web site associated with the URL will no longer be able to do so and will not be able to view its contents or order goods offered there, etc. Assuring timely and effective renewal of URL/domain name registration can be extremely important to the registrant and failure to maintain a registration in force could have disastrous and expensive results.

Yet avoiding lapse of registration and assuring timely renewal are, as a practical matter, a somewhat involved process. Experience reveals that many internet registrars do not keep accurate records. This can lead to unintended registration lapses, premature lapses and problems with renewals (e.g., registrant identity discrepancies).

For a party that wishes to obtain a particular URL if it becomes available through non-renewal, a registrar's failure to terminate a registration or to accept a new application on a timely basis also pose problems. For example, the would-be registrant may be entitled to apply for a registration and upon doing so be refused because the registrar does not acknowledge that the prior registration has lapsed.

Accordingly, those who register URLs have at least one or more of the following needs: to develop and maintain accurate records for their own registrations and those of the URLs they would like to acquire, to establish a “fail-safe” system to assure that their own registrations do not lapse for failure to renew and pay renewal fees timely and to create an institutional memory regarding URL registration-related matters. Naturally, a need also exists to perform these functions efficiently and in a manner that frees this important asset management role from the vagaries of individuals' memories and from turnover in the employment of the responsible individual or individuals. Consequently, an opportunity also exists to provide a service to registrants and would-be registrants of URLs whereby a third party can develop and maintain the appropriate records, for compensation.

### SUMMARY OF THE INVENTION

The foregoing and other objects and advantages as will appear hereinafter are achieved with a system and method by which an appropriate database is created and managed to trigger timely completion of all significant tasks involved in the URL registration and registration-maintenance processes.

There are many aspects to the present invention. To name a few:

According to a first aspect, the invention involves a system for managing the registration of internet Uniform Resource Locators (URLs), comprising first and second databases and a processor. The first database contains fields in which a first set of data are stored, the first set of data including, for a selected URL, user-generated data characterizing an application to register a URL. The processor is operable to access on-line information to determine whether the URL is already registered and, if so, to compare on-line information regarding the URL and the first set of data. After any discrepancies between the first set of data and the on-line information are resolved, the processor stores in the second database a second set of data, the second set of data including, for said URL, the first set of data with any discrepancies corrected and augmented by registration data from the on-line information. Thus, according to this aspect, the invention provides a first database for temporarily storing information pertaining to a URL of interest and a second database for permanently storing information pertaining to the URL, information being transferred from the first database to the second database after checking out and verifying the information or correcting it, if necessary.

According to a second aspect, the invention involves a method for managing the registration of internet Uniform Resource Locators (URLs). A URL and data associated with the URL are input to a first database. A determination is made whether the URL is already registered. If the URL is already registered, the data maintained by the registrar is compared with the data in the first database and, if the data maintained by the registrar is discrepant with any of the URL-associated data discrepancies are resolved. Once the discrepancies are resolved, the data associated with the URL in the first database is input to a second database. Before determining whether the URL is already registered, one may apply to register the URL and after receiving confirmation of registration, determine independently whether the URL is reported as registered and resolve any discrepancies between expected and reported registration data.

### BRIEF DESCRIPTION OF THE DRAWINGS

In the drawings,

FIG. 1 is a block diagram of an illustrative computer system having the databases and programming to operate in accordance with the invention;

FIG. 2 is a diagrammatic illustration of an illustrative Entry Table in a first database according to FIG. 1;

FIG. 3 is a diagrammatic illustration of an illustrative Main URL Table in a second database according to FIG. 1; and

FIGS. 4A and 4B together are a flow chart for an illustrative process according to the invention, for managing the tables of FIGS. 2 and 3.

### DETAILED DESCRIPTION

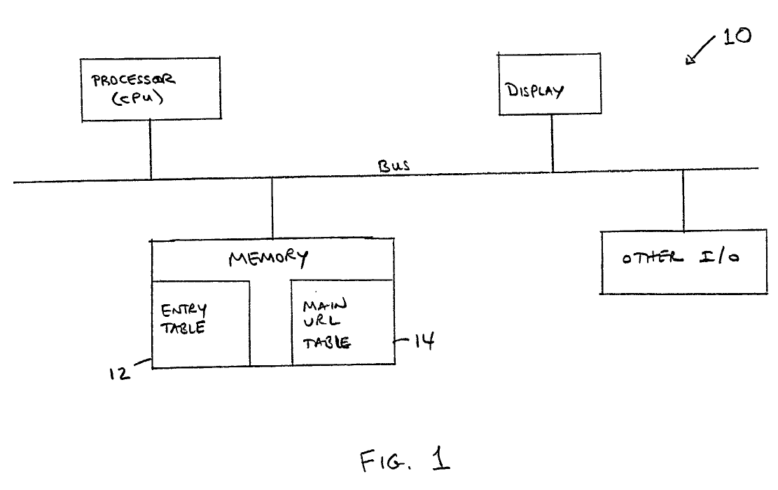

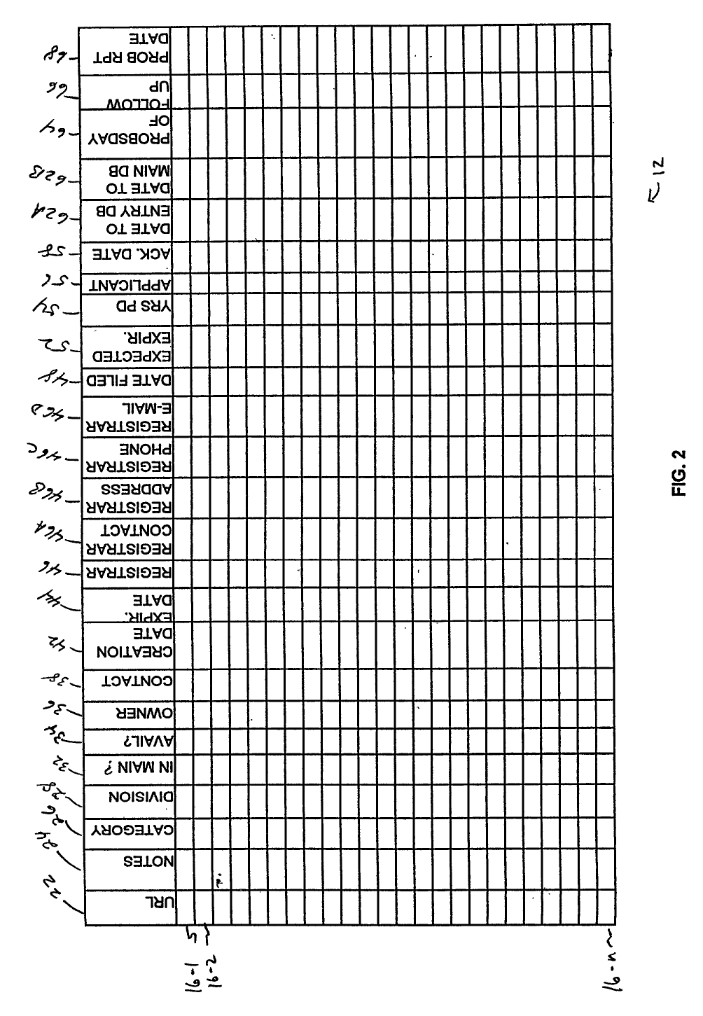

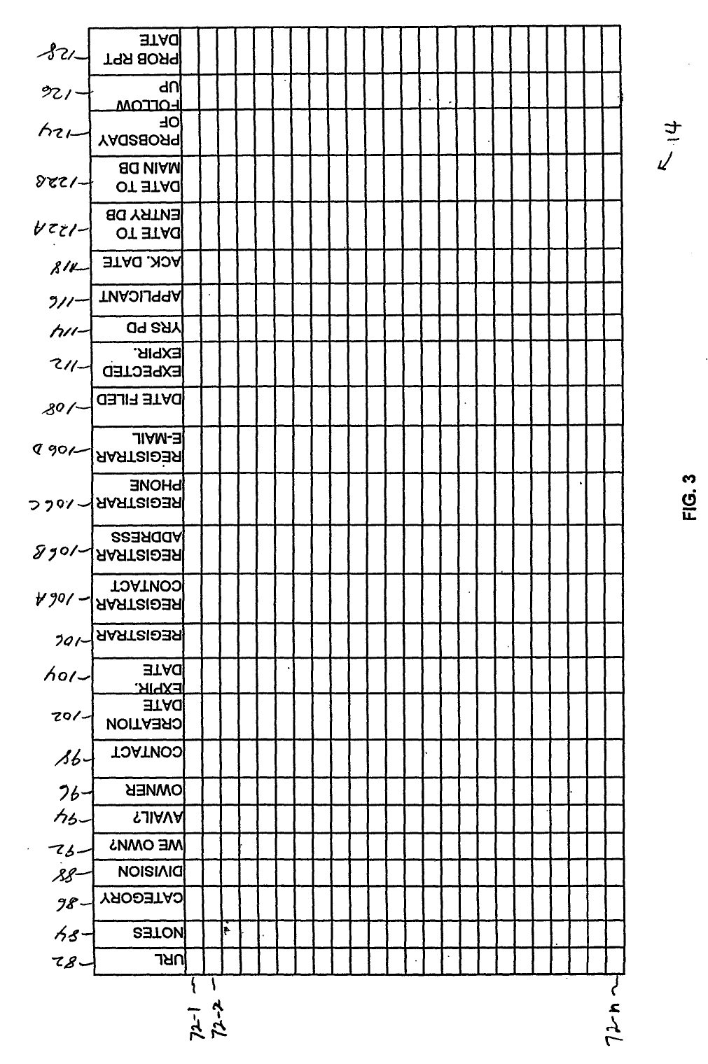

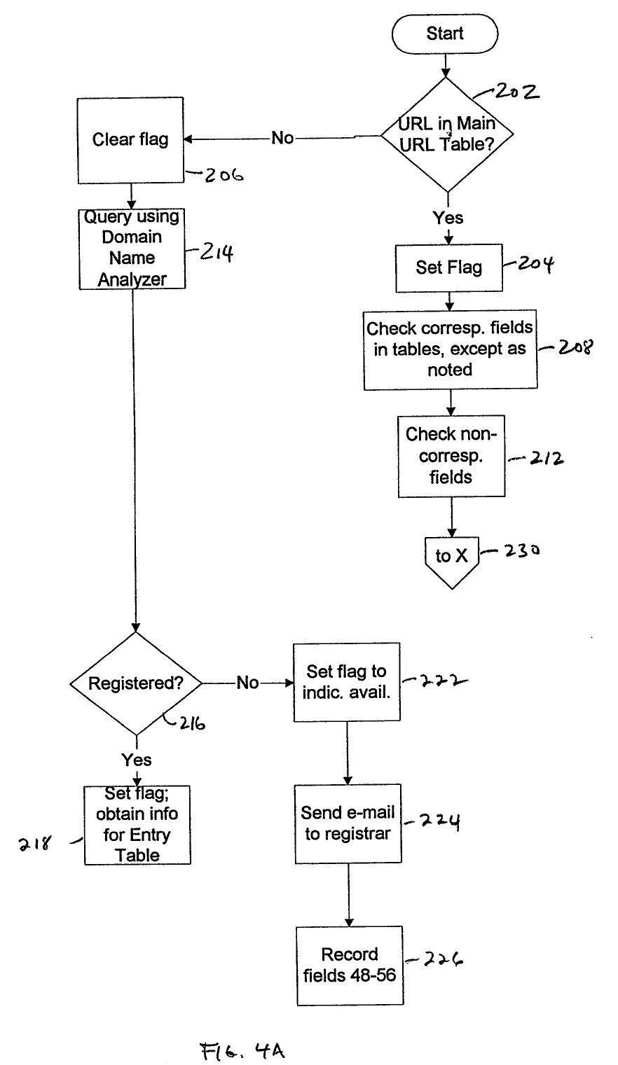

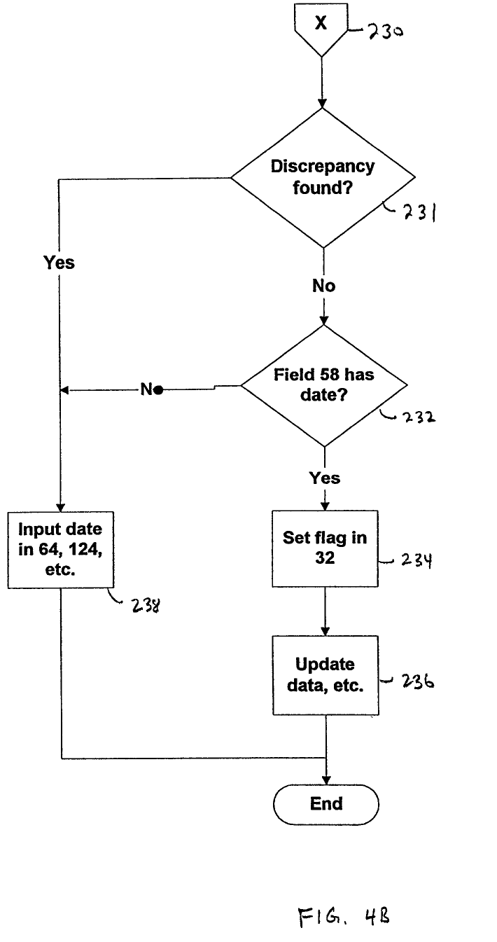

As shown in FIG. 1, in a computer system 10 having a conventional processor, memory, a display, and other input/output subsystems (such as keyboard, mouse, etc.), two databases 12 and 14 are provided to be used according to a process set forth herein. The first database 12 is referred to as an Entry Table and the second database 14, as the Main URL Table. An exemplary data structure of the database 12 is illustrated in FIG. 2 and of the database 14, in FIG. 3. An illustrative example of a process according to the invention, for managing the databases, is presented in FIGS. 4A and 4B. As shown in the figures, a record 16-i is opened in database 12 for each new URL (resulting in 16-1 through 16-n for n records). A record 16-i for an “i-th” URL preferably contains most or all of the following data fields: the URL 22; notes 24 relating to the URL (e.g., reasons for its acquisition); a category 26 for the URL (e.g., financial service, information site, sales site, company news site, etc.); if useful, an identification 28 of the division or subpart of the company or organization to which the URL pertains; a flag 32 indicating whether the URL is already entered in the Main URL Table 14; a flag 34 indicating whether the URL is available for use (i.e., is not already in use); the name of the owner 36; contact information for the owner 38 (which may include, in appropriate fields or sub-fields, for example, name, address, telephone number and e-mail addresses for administrative, technical and billing contacts); registered server information for the URL, 39; the URL “creation date” 42—i.e., the date the registrar (e.g., in a prior registration) created the registration; the expiration date of the registration 44; the name of the registrar 46 and any other relevant information about the registrar in optional supplemental fields, such as registrar contact name 46A, registrar address 46B, registrar telephone number 46C, and registrar e-mail address 46D (of course, this supplemental information can be maintained in a separate registrar information table, instead); the date an application was filed to register the URL (e.g., by e-mail) 48; the expected expiration date 52 of the registration; the number of years of registration purchased 54; the name of the applicant 56 as identified in the application (name sent); the date a successful e-mail application was established with the registrar (e.g., an acknowledgment was received) 58; the date 62A when the URL is entered into the Entry Table 12; the date 62B when the URL is entered into Main URL Table; the date 64, identified as “problemsdayof”, when a problem was brought to the attention of the registrar, such as a reported registration date (obtained from the registrar's publicly published information) not conforming to the registrant's information; a date one week later, 66, to be used as a follow-up calendar entry; and a date 68 of a report (from a registrar) from which it has been noted that there is a pending problem (i.e., discrepancy). One may wish to add fields for the identity of the registrar whose report is discrepant, as the report might not come from the registrar of record, as well as the date or month of that report.

Manually, information in fields 22, 24, 26 and 28 is entered into a record in the Entry Table. An automated process then takes over, as illustrated by the flow chart of FIGS. 4A and 4B. Process 200 begins by checking (202) whether the URL in field 22 of the record is already in the Main URL Table and then sets (204) or clears (206) the flag in field 32 accordingly. The operation of checking the Entry Table against the Main URL Table mostly amounts to checking corresponding fields in the two tables, 208, but in act 212 three columns 5 (i.e., fields) in a record 16-i in the Entry Table 12 are checked against different columns of a corresponding record 72-i in the Main URL Table 14. The “date applied” field 48 is checked against the “creation date” field 102 in the Main URL Table; the expected expiration date field 52 is checked against the “expiration date” field 104 in the Main URL Table and the “name sent” field 56 is compared to the “owner” field 96 in the Main URL Table. One field, 32, is contained only in the Entry Table and thus is not checked against the Main URL Table.

If the URL is not in the Main URL Table, then using a domain name analyzer, which is a commercially available software product, availability of the URL is queried, 214. If the URL is already registered (the “yes” outcome of decision 216), then in act 218 the flag in field 34 is set accordingly and the information for fields 36 - 46 is obtained and input to the Entry Table. However, if the URL is not registered (the “no” outcome of decision 216), the flag in field 34 is set to indicate availability, 222, and an e-mail message is sent to a selected registrar with the information needed to effect registration of the URL, 224. At that time, the information for fields 48 - 56 is recorded, 226. In field 54, there is recorded the number of years of registration purchased. Preferably, there is also recorded in field 54A the registration fee paid; and in field 54B, the fee per year. Further, there may be a link to another URL table (not shown) in which the following information (or at least some of it) is recorded: the total registration fee paid, total number of years of registration purchased, the per-year registration fee, expiration data and registrar. Each time a payment is made (e.g., for renewal), a new “row” may be created in the table, with up to date information. This table will then contain a payment history. The Entry Table and Main URL Table may then contain only the most current payment and registration information.

When the registrar returns an e-mail message of a successful or unsuccessful registration, the date is entered in field 58 (an act not shown).

If there is no discrepancy between the Entry Table and the Main URL Table, and field 58 has a date in it to indicate that a successful registration e-mail was sent (the “yes” branch of 232), then the flag in field 32 is set, 234, to indicate that the entry is already in the Main URL Table. Also, the URL information in the Main URL Table may be updated or new information appended and the then current date is inserted in field 62, act 236.

A domain name analyzer also may be used when the URL is already in the Main URL Table, to confirm that the data reported by the domain name analyzer is consistent with the data in the Main URL Table. If there are inconsistencies, they should be identified and resolved.

Optionally, a group of URLs may be associated by assigning to each of them a same group number (in fields 22A and 82A, for example). One URL in the group may be flagged as a lynchpin by, for example, setting a flag in fields 22B and 82B. If a group number has been assigned for a URL, then optionally an application is not filed for that URL unless the lynchpin URL is available. This conserves registration fees and registration maintenance when the group of URLs is not desirable unless the lynchpin URL is available.

If, upon checking the Entry Table record against the Main URL Table a discrepancy is noted in the recorded data (the “yes” branch from 23 1), then the current date is input to field 64 and the corresponding field 124 in the Main URL Table, act 238. Further, if field 58, successful email, has a date in it, but there are discrepancies with the Main URL Table, then the field “we own” 92 in the Main URL Table is updated to a value of “yes”.

On a frequent basis, reports may be generated of all URLs that have a date in the “problemsdayof” field 64. Such a report may identify the actual discrepancy. The user may then contact the registrar to resolve the discrepancy. Once the discrepancy is resolved, the date is cleared.

Reports may also be generated, on demand, of all URLs checked into on a given day or time period. Such a report typically would show a URL, whether it was successfully registered, the owner's name if the registration was not successful, and the expiration date.

One week after the date entered in field 62, or at such other time as shall be selected, the URL is double-checked against the information obtained by a domain name analyzer. This is done to assure that the registrar correctly recorded the registration. If any discrepancy is noted, such as a registration date, that could result in a registration renewal being late and the URL being lost. Therefore, the current date is entered into field 66 (“problems 1 week”) as well as the corresponding field in the Main URL Table and each discrepancy is followed up by an inquiry to the registrar. For such URLs, a report preferably is generated showing the details of the discrepancies.

A monthly report is obtained from a registrar and such report is input to an appropriate database. Such report is then compared to the information in the Entry Table. If there is a discrepancy, a date is inserted in field 68 (“problems month report”) and the corresponding field in the Main URL Table. A report is created of all such URLs with discrepancies, for follow up. The process of inputting these reports to a database, comparing them to the Entry Table information and inserting a date in field 68 when there is a discrepancy may be automated readily. For example, each registrar typically reports its data in a specific format, so a template can be created for extracting the data from the registrar's monthly report.

The monthly report database is compared with the information in the Entry Table and if there are URLs in the monthly report which were not in the Entry Table, a report is generated showing all URLs that are not yet in the Main URL Table, with all the information supplied by the registrar.

Diligent follow up of all discrepancy reports should result in resolution of all discrepancies well before a discrepancy could cause rights to be lost.

At some predetermined time before expiration of a self-owned registration, a notification is provided to the user. This may be done in a regularly generated report or by an automatically generated e-mail, for example. The user-registrant can then effect a timely renewal. If it is decided not to renew a registration, a note explaining the reason behind that decision may be recorded in a general notes field or a notes field dedicated to that use, in the Main URL Table, which notes fields have not been illustrated in order to simplify the drawings. For registrations of others that are being monitored, notifications can be generated automatically upon or shortly after an expiration date and application can then be made to obtain the URL in the event the registrant failed to renew in a timely fashion. Should the decision be made not to apply to register a monitored URL once it becomes available, a note may be made in the general notes field to make a record of the reason.

Preferably, the database software maintains an audit trail so that all changes to fields can be tracked. One way to do so is to provide another table (not shown), linked to the Main URL Table. Its purpose is to record, for each URL, all changes made in the Main URL Table contents (beginning with the initial entry for a URL), indexed by date. This will allow all Main URL Table changes to be tracked by date of change. A notes field is preferably provided and information explaining the reason for each change is entered there when a change occurs.

Thus, an efficient system and method are shown for managing both small and large URL portfolios, satisfying the various needs expressed above.

This system and method may be practiced by a registrant or would-be registrant or by a third party on behalf of the registrant or would-be registrant. That is, a third party may operate a business which practices the method and utilizes the described system for one or more customers who have or desire to have URL registrations. The third party develop and maintain the appropriate records, for compensation.

The term “database,” as used herein, refers to a computer-readable medium on which there is stored data in an organized fashion. This includes, but is not limited to, flat-file and relational organizations of data. The databases utilized by the present invention and the process flow discussed herein may be practiced using any of a number of commercially available database products and programming tools, as will readily occur to software engineers and others.

Having described an illustrative embodiment of such a system and method, as well as certain variations thereof, it will be appreciated that various additions, deletions, enhancements and modifications will readily occur to those skilled in the art. For example, when a URL is found to have been registered, the interested party may use a domain name analyzer to check out the registration data supplied not only by the registrar of that URL (typically using the registrar's “whois” service), but also the data held in other “shadow” registration databases. While the URL registrar or root registrar is supposed to propagate its registration information all of the registration databases or resolvers on the internet, and they thus should contain the same registration information, that is not always what happens. Thus, it is desirable to compare the data from each shadow registration database with the data in the Main URL Table or the Entry Table, as the case may be, and to effect resolution of any discrepancies. Further, the Main URL Table and Entry Table need not contain all the fields illustrated and the data collected and input to the Entry Table and the Main URL Table need not include all the data shown. Indeed, while two separate tables are illustrated (the Entry Table and the Main URL Table), it will be appreciated that the two tables may be combined into one database or arranged into more than two databases so long as storage is provided for temporary information and for permanent information regarding URLs of interest, allowing detection and resolution of discrepancies between information maintained by a URL registrar and a URL registrant or would-be registrant. When used herein, the term “database” is not limited to a particular computer program used for storing and accessing information but includes any data structure for storing information and may include the computer program or programs employed for creating the data structure, writing information to the data structure and/or retrieving information from the data structure. Accordingly, the foregoing discussion and the drawings are presented by way of example only.

What is claimed is:

1. A system for managing the registration of internet Uniform Resource Locators (URLs), comprising:
a first database containing fields in which a first set of data are stored, the first set of data including, for a selected URL, user-generated data characterizing an application to register a URL; and
a processor operable to access on-line information to determine whether the URL is already registered and, if so, to compare on-line information regarding the URL and the first set of data and after any discrepancies between the first set of data and the on-line information are resolved, to store in a second database a second set of data, the second set of data including, for said URL, the first set of data with any discrepancies corrected and augmented by registration data from the on-line information.

2. A method for managing the registration of internet Uniform Resource Locators (URLs), comprising:
inputting to a first database a URL and data associated with the URL;
determining whether the URL is already registered;
if the URL is already registered, determining whether data maintained by a registrar is discrepant with any of the URL associated data and, if so, resolving the discrepancies;
once the discrepancies are resolved, inputting the data associated with the URL in the first database to a second database.

3. The method of claim 2 further including, before determining whether the URL is already registered, applying to register the URL and determining whether the URL is already registered only after receiving confirmation of registration.
